(19) United States
(12) Patent Application Publication
(10) Pub. No.: US 2026/0351159 A1
(43) Pub. Date: Nov. 5, 2026

(54) LEVEL SHIFTER AND DISPLAY DRIVING DEVICE COMPRISING SAME

(71) Applicant: Da Sol WON

(72) Inventor: Da Sol WON

(21) Appl. No.: 19/115,674

(22) PCT Filed: Sep. 25, 2023
(86) PCT No.: PCT/KR2023/014631

§ 371 Date: Mar. 26, 2025

(30) Foreign Application Priority Data
Sep. 27, 2022 (KR) 1020220122172
Jan. 31, 2023 (KR) 1020230013077

(51) Int. Cl. G09G 3/20

(52) U.S. Cl. CPC G09G 3/2096; G09G 2310/027; G09G 2310/0289; G09G 2330/021; G09G 2330/025

(57) ABSTRACT

A display driving device includes a level shifter for shifting, to an output signal of a second level voltage and an inverted output signal obtained by inverting the output signal, an input signal of a first level voltage and an inverted input signal obtained by inverting the input signal; and a digital analog converter (DAC) which is composed of a plurality of DAC transistors, and which converts the output signal and the inverted output signal into analog image signals, wherein the level shifter includes an output limit circuit for limiting the voltage levels of the output signal and the inverted output signal to the second level voltage by applying a bias voltage to the gate terminals of output limit transistors so that a turn-on period of a DAC transistor to which the output signal is applied does not overlap a turn-on period of a DAC transistor to which the inverted output signal is applied.

### CROSS-REFERENCE TO RELATED APPLICATIONS

This application is a national phase entry of PCT International Application No. PCT/KR2023/014631 filed on Sep. 25, 2023, which claims the priorities of Korean Application Nos. 10-2022-0122172 filed on Sep. 27, 2022, and 10-2023-0013077 filed on Jan. 31, 2023, which are hereby incorporated by reference in their entirety.

### BACKGROUND

### Field of the Disclosure

The present disclosure relates to a semiconductor integrated circuit, and more particularly, to a level shifter of a display device.

### Description of the Background

A display driving device that drives data lines included in a display device includes a digital-to-analog converter (DAC; hereinafter referred to as “DAC”) and level shifters.

For the sake of brevity, this specification describes a source driver integrated circuit (source driver IC), which serves as an example of the display driving device, but the present disclosure is applicable to any type of display driving device.

Each of the level shifters shifts the voltage level of each input digital video signal to generate an output digital video signal with a shifted voltage level, to control the on or off state of each switch included in the DAC and consuming dynamic current.

In response to the output digital video signals whose voltage levels are shifted by the level shifters, the switches included in the DAC output one of the grayscale voltages generated by a grayscale voltage generator to one of the data lines.

However, as the resolution of the display device increases, the number of source driver ICs also increases in proportion to the resolution. That is, the number of level shifters increases while the driving time decreases, causing a short between an output signal and an inverted output signal outputted from the level shifter. Consequently, there is a problem in which the current consumption caused by the short occurring in the DAC, which receives the output signal and the inverted signal from the level shifter, increases.

### SUMMARY

To solve the above-mentioned problems, the present disclosure is to provide a level shifter capable of preventing a plurality of transistors included in a digital-to-analog converter from being turned on simultaneously, and a source driver IC including the same.

Additionally, the present disclosure is to provide a level shifter capable of reducing the power consumption of a source driver IC, and the source driver IC including the same.

A display driving device according to an aspect of the present disclosure for achieving the aforementioned technical objectives includes: a level shifter configured to shift an input signal at a first level voltage and an inverted input signal obtained by inverting the input signal into an output signal at a second level voltage and an inverted output signal obtained by inverting the output signal; and a digital-to-analog converter (DAC) composed of a plurality of DAC transistors and configured to convert the output signal and the inverted output signal into an analog image signal, wherein the level shifter includes an output limiting circuit configured to limit voltage levels of the output signal and the inverted output signal to the second level voltage by applying a bias voltage to gate terminals of output limiting transistors, such that a turn-on period of the DAC transistor to which the output signal is inputted does not overlap a turn-on period of the DAC transistor to which the inverted output signal is inputted.

A level shifter according to another aspect of the present disclosure for achieving the aforementioned technical objectives includes: an input circuit to which an input signal and an inverted input signal are inputted; an output circuit configured to output an output signal generated based on the input signal to a first DAC transistor through a first output line, and to output an inverted output signal generated based on the inverted input signal to a second DAC transistor through a second output line; and an output limiting circuit configured to adjust a slope of a rising edge of the output signal or a slope of a falling edge of the inverted output signal such that a turn-on period of the first DAC transistor does not overlap a turn-on period of the second DAC transistor.

According to the present disclosure, it is possible to prevent the plurality of transistors included in the digital-to-analog converter from being turned on simultaneously, thereby preventing a short circuit in the digital-to-analog converter.

In addition, according to the present disclosure, by preventing a short circuit in the digital-to-analog converter, the power consumption of buffers included in the source driver IC may be reduced, thereby enabling low-power driving of the source driver IC, and this may also reduce the driving delay time of the source driver IC, thereby ensuring sufficient output driving time for high-resolution displays and improving image quality.

### BRIEF DESCRIPTION OF THE DRAWINGS

FIG. 1 is a block diagram of a display device including a source driver IC according to one aspect of the present disclosure.

FIG. 2 is a block diagram of the source driver IC included in the display device of FIG. 1.

FIG. 3 is a circuit diagram of a first level shifter included in the source driver IC of FIG. 2.

FIG. 4 is a diagram illustrating a first output signal and a first inverted output signal outputted from a first level shifter.

FIG. 5 is a circuit diagram of a first DAC included in the source driver IC of FIG. 2.

FIG. 6 is a circuit diagram of a first level shifter according to another aspect of the present disclosure.

FIG. 7 is a circuit diagram of a second level shifter included in the source driver IC of FIG. 2.

FIG. 8 is a diagram illustrating a second output signal and a second inverted output signal outputted from a second level shifter.

FIG. 9 is a circuit diagram of a second DAC included in the source driver IC of FIG. 2.

FIG. 10 is a diagram illustrating a second output signal and a second inverted output signal outputted from a second level shifter connected to each output line.

### DETAILED DESCRIPTION

Throughout the specification, the same reference numerals refer to substantially the same components. In the following description, detailed descriptions of configurations and features known in the art may be omitted if they are not relevant to the core configuration of the present disclosure. Terms used in this specification should be understood as follows.

The advantages and features of the present disclosure, and methods of achieving them will be apparent from the embodiments described in detail below in conjunction with the accompanying drawings. However, the present disclosure is not limited to the following embodiments, but may be implemented in various different forms; rather, the present embodiments are provided to make the description of the present disclosure complete and to allow those skilled in the art to fully understand the scope of the present disclosure, and the present disclosure is defined only within the scope of the appended claims.

The shapes, sizes, proportions, angles, numbers and the like shown in the accompanying drawings for the purpose of illustrating the embodiments of the present disclosure are merely examples, and the present disclosure is not limited thereto. Identical reference numerals may designate identical components throughout the description. Further, in describing the present disclosure, detailed descriptions of known related technologies may be omitted if it is considered to unnecessarily obscure the gist of the present disclosure.

The terms such as “comprising,” “including,” “having,” and “consisting of” used herein are generally intended to allow other components to be added unless the terms are used with the term “only.” References to components of a singular noun include the plural of that noun, unless specifically stated otherwise.

In interpreting components, they are construed to include a margin of error, even if it is not explicitly stated.

When describing a positional relationship, for example, “on,” “above,” “below,” or “next to” describes the positional relationship of two parts, one or more other parts may be located between the two parts, unless “immediately” or “directly” is used.

When describing a temporal contextual relationship is described, for example, such as “after,” “following,” “next to,” or “before,” it may also include non-contiguous cases unless “immediately” or “directly” is used.

The first, the second, and so on are used to describe various components, but these components are not limited by these terms. These terms are used only to distinguish one component from another. Therefore, the first component referred to herein may also be a second component within the technical idea of the present disclosure.

It should be understood that the term “at least one” includes any combination that may be presented from one or more relevant items. For example, the phrase of “at least one of the first, second, and third items” may mean each of the first, second, or third items, as well as any combination of items that may be presented from two or more of the first, second, and third items.

Each of the features of various embodiments of the present disclosure may be coupled or combined with one another in whole or in part, and may be technologically interlocked and operated in various ways, and each of the embodiments may be carried out independently or in conjunction with one another.

Hereinafter, embodiments of the present specification will be described in detail with reference to the accompanying drawings.

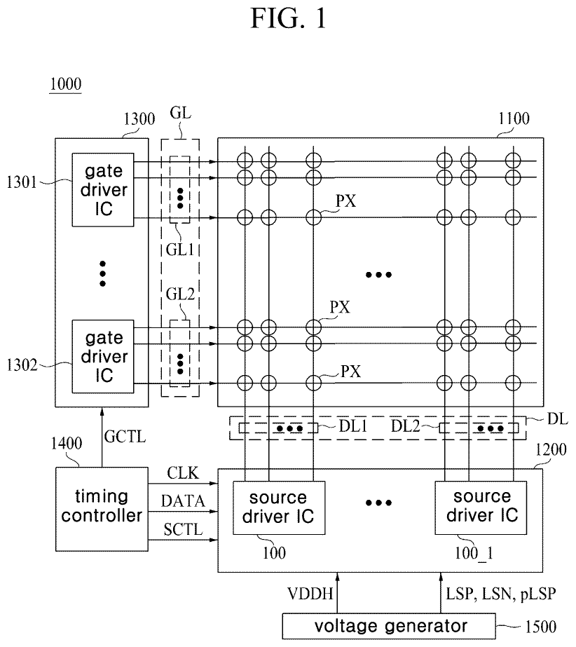

FIG. 1 is a block diagram of a display device including a source driver IC according to one aspect of the present disclosure.

As shown in FIG. 1, a display device 1000 according to the present disclosure includes a display panel 1100, a source driver IC block 1200, a gate driver IC block 1300, a timing controller 1400, and a voltage generator 1500. Although FIG. 1 exemplarily shows the voltage generator 1500 as being located outside the source driver IC block 1200, the voltage generator 1500 may be implemented inside the source driver IC block 1200 or inside each of the source driver ICs 100 and/or 100_1 depending on embodiments.

The display device 1000 may be a liquid crystal display (LCD) device, a light-emitting diode (LED) display device, an organic light-emitting diode (OLED) display device, or an active-matrix organic light-emitting diode (AMOLED) display device. For example, the display device 1000 may be a laptop computer.

The display panel 1100 includes a plurality of gate lines GL, a plurality of data lines DL, and a plurality of pixels PX. The plurality of pixels PX are connected to each of the gate lines GL and each of the data lines DL and are arranged in a matrix form.

The source driver IC block 1200 includes a plurality of source driver ICs 100 and 100_1 that drive the data lines DL. In one aspect, the data lines DL may be referred to as channels, and the source driver ICs 100 and 100_1 may be referred to as data driver ICs.

For example, a first source driver IC 100 drives a first group of data lines DL1 among the data lines DL, and a second source driver IC 100_1 drives a second group of data lines DL2 among the data lines DL. It is assumed that the structures of the source driver ICs 100 and 100_1 are identical.

The gate driver IC block 1300 includes a plurality of gate driver ICs 1301 and 1302 that generate gate driving signals to drive the gate lines GL.

For example, a first gate driver IC 1301 generates first gate driving signals for driving a first group of gate lines GL1 among the gate lines GL, and a second gate driver IC 1302 generates second gate driving signals for driving a second group of gate lines GL2 among the gate lines GL. It is assumed that the structures of the gate driver ICs 1301 and 1302 are identical.

The timing controller 1400 generates gate driver control signals GCTL for controlling the operation of each of the plurality of gate driver ICs 1301 and 1302, and outputs them to the plurality of gate driver ICs 1301 and 1302.

In addition, the timing controller 1400 generates a clock signal CLK, input data DATA, and source driving control signals SCTL and outputs them to the plurality of source driver ICs 100 and 100_1.

The voltage generator 1500 generates a first operating voltage VDDH and a ground voltage VSSH and outputs them to the plurality of source driver ICs 100 and 100_1.

In one aspect, the voltage generator 1500 may further generate a first bias voltage LSN, a second bias voltage LSP, and a pre-bias voltage pLSP to be supplied to the source driver ICs 100 and 100_1.

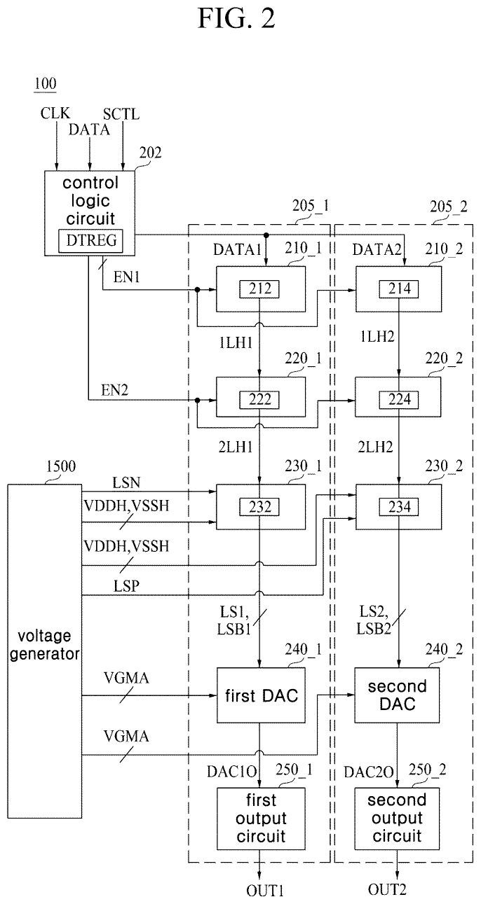

FIG. 2 is a block diagram of the source driver IC included in the display device of FIG. 1.

Referring to FIGS. 1 and 2, since the structures of the source driver ICs 100 and 100_1 are identical, the structure and operation of the first source driver IC 100 are described in detail (or representatively) with reference to FIGS. 1 to 10.

The first source driver IC 100 includes a control logic circuit 202, a first data processing circuit 205_1, and a second data processing circuit 205_2.

The control logic circuit 202 extracts (or separates) first data and second data from the serial input display data DATA by using the clock signal CLK, and outputs the extracted data DATA1 or DATA2 to the first data processing circuit 205_1 and the second data processing circuit 205_2 in a time division manner. For example, the control logic circuit 202 may extract odd-numbered data as the first data DATA1 and even-numbered data as the second data DATA2 from the serial input display data DATA by using the clock signal CLK.

Therefore, it is assumed that in response to first latch enable signals EN1, when the first data processing circuit 205_1 operates, the second data processing circuit 205_2 does not operate, and when the second data processing circuit 205_2 operates, the first data processing circuit 205_1 does not operate.

The first data processing circuit 205_1 receives the first data DATA1 outputted from the control logic circuit 202, processes it (e.g., sequentially performs a latch operation, a serial-to-parallel converting operation, a voltage level shifting operation, and a digital-to-analog converting operation), and outputs a processing result OUT1 to one of the first data lines DL1.

The first data processing circuit 205_1 includes a first latch circuit 210_1, a second latch circuit 220_1, a first level shifter circuit 230_1, a first DAC 240_1, and a first output circuit 250_1.

The first latch circuit 210_1 includes first latches 212 and latches (or converts) the serial first data DATA1 into parallel first data 1LH1 in response to the first latch enable signals EN1. In one aspect, the first latches 212 may be D-flip-flops capable of latching 1-bit data, and the first latch enable signals EN1 may be parallel signals activated at different timings.

The second latch circuit 220_1 includes second latches 222, and each of the second latches 222 latches the data 1LH1 in response to a second latch enable signal EN2 and outputs the latched data 2LH1 to the first level shifter circuit 230_1.

The first level shifter circuit 230_1 shifts the data 2LH1 outputted from the second latch circuit 220_1 to a predetermined level and outputs the shifted data. For this purpose, the first level shifter circuit 230_1 includes first level shifters 232.

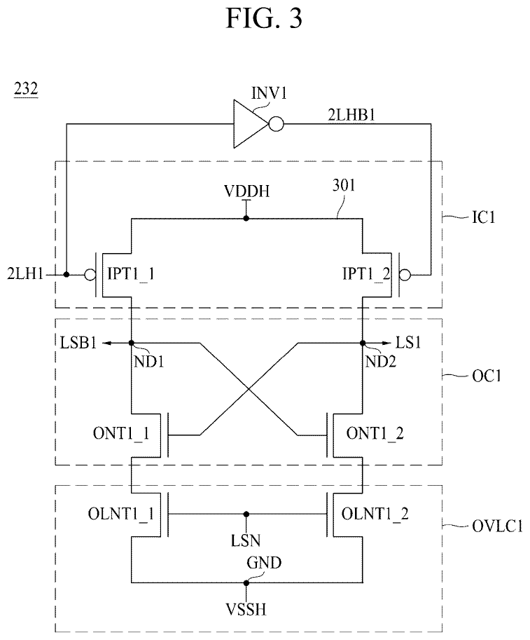

Hereinafter, the configuration of the first level shifter will be described in more detail with reference to FIGS. 2 and 3.

FIG. 3 is a circuit diagram of a first level shifter included in the source driver IC shown in FIG. 2. In one aspect, the first level shifter 232 shown in FIG. 3 may be connected to the first DAC 240_1 composed of p-type transistors.

The first level shifter 232 shown in FIG. 3 shifts the first input signal 2LH1 at a first level voltage to a first output signal LS1 at a second level voltage and a first inverted output signal LSB1 obtained by inverting the first output signal LS1. Accordingly, the first level shifter 232 outputs the complementary signal pair LS1 and LSB1 to the first DAC 240_1.

To this end, the first level shifter 232 includes a first input circuit IC1, a first output circuit OC1, and a first output limiting circuit OVLC1.

The first input circuit ICI receives the first input signal 2LH1 at the first level voltage and a first inverted input signal 2LHB1 obtained by inverting the first input signal 2LH1. For this purpose, the first input circuit IC1 includes a first-first input PMOS transistor IPT1_1 and a first-second input PMOS transistor IPT1_2.

The gate of the first-first input PMOS transistor IPT1_1 receives the first input signal 2LH1 at the first level voltage, the first terminal of the first-first input PMOS transistor IPT1_1 is connected to a first voltage transmission line 301 for transmitting the first operating voltage VDDH, and the second terminal of the first-first input PMOS transistor IPT1_1 is connected to a first node ND1.

The gate of the first-second input PMOS transistor IPT1_2 receives the first inverted input signal 2LHB1. In this case, a first inverter INV1 inverts the first input signal 2LH1, and inputs the inverted first inverted input signal 2LHB1 to the gate of the first-second input PMOS transistor IPT1_2. The first terminal of the first-second input PMOS transistor IPT1_2 is connected to the first voltage transmission line 301 for transmitting the first operating voltage VDDH, and the second terminal of the first-second input PMOS transistor IPT1_2 is connected to a second node ND2.

In this case, when the level of the first input signal 2LH1 inputted to the gate of the first-first input PMOS transistor IPT1_1 is high and the level of the signal 2LHB1 inputted to the gate of the first-second input PMOS transistor IPT1_2 is low, the first-first input PMOS transistor IPT1_1 is turned off and the first-second input PMOS transistor IPT1_2 is turned on. Conversely, when the level of the first input signal 2LH1 inputted to the gate of the first-first input PMOS transistor IPT1_1 is low and the level of the first inverted input signal 2LHB1 inputted to the gate of the first-second input PMOS transistor IPT1_2 is high, the first-first input PMOS transistor IPT1_1 is turned on and the first-second input PMOS transistor IPT1_2 is turned off.

The first output circuit OC1 is a circuit that outputs the first output signal LS1 and the first inverted output signal LSB1 obtained by inverting the first output signal LS1, and includes a first-first output NMOS transistor ONT1_1 and a first-second output NMOS transistor ONT1_2.

The first output limiting circuit OVLC1 receives the first bias voltage LSN and limits the voltage levels of the first output signal LS1 and the first inverted output signal LSB1 to the second level voltage.

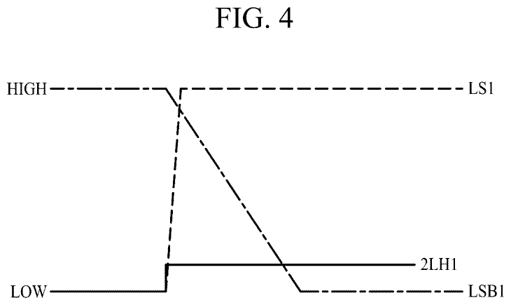

In particular, when the first level shifter 232 is connected to the first DAC 240_1 composed of p-type transistors, the first output limiting circuit OVLC1 according to the present disclosure may, as shown in FIG. 4, adjust the slope characteristics of the rising edge of the first output signal LS1 and the falling edge of the first inverted output signal LSB1 through the application of the first bias voltage LSN. The first output limiting circuit OVLC1 outputs the first output signal LS1 and the first inverted output signal LSB1 with adjusted slope characteristics to the first DAC 240_1 to prevent a DAC short caused by the simultaneous turn-on of a DAC transistor to which the first output signal LS1 is applied and a DAC transistor to which the first inverted output signal LSB1 is applied, thereby reducing the current consumption in the source driver IC.

To this end, the first output limiting circuit OVLC1 includes a first-first output limiting NMOS transistor OLNT1_1 and a first-second output limiting NMOS transistor OLNT1_2. The first output limiting circuit OVLC1 inputs the first bias voltage LSN to the gates of the first-first output limiting NMOS transistor OLNT1_1 and the first-second output limiting NMOS transistor OLNT1_2, which are n-type transistors, thereby allowing the slope of the rising edge of the first output signal LS1 to increase. This is because an N-bias type, in which a bias voltage is applied to the gates of the first-first output limiting NMOS transistor OLNT1_1 and the first-second output limiting NMOS transistor OLNT1_2, which are n-type transistors, is characterized by slow rising and fast falling edges, which increases the slope of the rising edge of the first output signal LS1 finally outputted from the first level shifter 232, thereby enhancing the turn-off characteristics of the DAC transistors.

As a result, the transition time from turn-on to turn-off of a first-first DAC PMOS transistor, to which the first output signal LS1 is inputted, is reduced compared to the transition time from turn-off to turn-on of a first-second DAC PMOS transistor, to which the first inverted output signal LSB1 is inputted. In other words, the turn-off of the first-first DAC PMOS transistor is performed before the turn-on of the first-second DAC PMOS transistor, thereby preventing the occurrence of a DAC short caused by the simultaneous turn-on of the first-first DAC PMOS transistor and the first-second DAC PMOS transistor.

Hereinafter, with reference to FIG. 3, the connection relationship of the transistors included in the first level shifter 232 and the operation of each transistor will be described in more detail.

As shown in FIG. 3, the transistors IPT1_1, ONT1_1, and OLNT1_1 are connected in series between the first voltage transmission line 301 for transmitting the first operating voltage VDDH and a ground GND for supplying the ground voltage VSSH, and the transistors IPT1_2, ONT1_2, and OLNT1_2 are connected in series between the first voltage transmission line 301 and the ground GND.

The gate of the first-first output NMOS transistor ONT1_1 is connected to the second node ND2, the first terminal of the first-first output NMOS transistor ONT1_1 is connected to the first node ND1, and the second terminal of the first-first output NMOS transistor ONT1_1 is connected to the first-first output limiting NMOS transistor OLNT1_1. The gate of the first-second output NMOS transistor ONT1_2 is connected to the first node ND1, the first terminal of the first-second output NMOS transistor ONT1_2 is connected to the second node ND2, and the second terminal of the first-second output NMOS transistor ONT1_2 is connected to the first-second output limiting NMOS transistor OLNT1_2.

The gate of the first-first output limiting NMOS transistor OLNT1_1 receives the first bias voltage LSN, the first terminal of the first-first output limiting NMOS transistor OLNT1_1 is connected to the first-first output NMOS transistor ONT1_1, and the second terminal of the first-first output limiting NMOS transistor OLNT1_1 is connected to the ground voltage VSSH. The gate of the first-second output limiting NMOS transistor OLNT1_2 receives the first bias voltage LSN, the first terminal of the first-second output limiting NMOS transistor OLNT1_2 is connected to the first-second output NMOS transistor ONT1_2, and the second terminal of the first-second output limiting NMOS transistor OLNT1_2 is connected to the ground voltage VSSH.

In one aspect, the first-first output limiting NMOS transistor OLNT1_1 and the first-second output limiting NMOS transistor OLNT1_2 are turned on by receiving the first bias voltage LSN at their gates, and the voltages applied to their respective first terminals are limited by the first bias voltage LSN, so that the first output signal LS1 and the first inverted output signal LSB1 outputted to the first node ND1 and the second node ND2 may be limited to the second level voltage. Additionally, due to the unique characteristics of the N-bias type in which a bias voltage is applied to an N-type transistor, the slope of the rising edge of the first output signal LS1 increases, reducing the transition time from turn-on to turn-off of the first-first DAC PMOS transistor to which the first output signal LS1 is inputted, thereby preventing a short circuit between the first-first DAC PMOS transistor and the first-second DAC PMOS transistor.

In one aspect, when the level of the first input signal 2LH1 inputted to the gate of the first-first input PMOS transistor IPT1_1 is low and the level of the first inverted input signal 2LHB_1 inputted to the gate of the first-second input PMOS transistor IPT1_2 is high, the first-first input PMOS transistor IPT1_1 is turned on and the first-second input PMOS transistor IPT1_2 is turned off. When the first-first input PMOS transistor IPT1_1 is turned on, the voltage LSB1 at the first node ND1 is pulled up to the second level voltage limited by the first-first output limiting NMOS transistor OLNT1_1, and the first-second output NMOS transistor ONT1_2 is turned on, causing the first output signal LS1, which is the voltage at the second node ND2, to be pulled down to the ground voltage VSSH. Accordingly, the first-first output NMOS transistor ONT1_1 is turned off, and thus the voltage LSB1 at the first node ND1 maintains the second level voltage. That is, when the level of the first input signal 2LH1 inputted to the gate of the first-first input PMOS transistor IPT1_1 is low, and the level of the first inverted input signal 2LHB1 inputted to the gate of the first-second input PMOS transistor IPT1_2 is high, the first level shifter 232 outputs the ground voltage VSSH as the first output signal LS1 and the second level voltage as the first inverted output signal LSB1.

Conversely, when the level of the first input signal 2LH1 inputted to the gate of the first-first input PMOS transistor IPT1_1 is high and the level of the first inverted input signal 2LHB1 inputted to the gate of the first-second input PMOS transistor IPT1_2 is low, the first-first input PMOS transistor IPT1_1 is turned off and the first-second input PMOS transistor IPT1_2 is turned on. When the first-second input PMOS transistor IPT1_2 is turned on, the first output signal LS1, which is the voltage at the second node ND2, is pulled up to the second level voltage limited by the first-second output limiting NMOS transistor OLNT1_2, and the first-first output NMOS transistor ONT1_1 is turned on, causing the voltage at the first node ND1 to be pulled down to the level of the ground voltage VSSH. Accordingly, the first-second output NMOS transistor ONT1_2 is turned off, and thus the first output signal LS1, which is the voltage at the second node ND2, is maintained at the second level voltage. That is, when the level of the first input signal 2LH1 inputted to the gate of the first-first input PMOS transistor IPT1_1 is high and the level of the first inverted input signal 2LHB1 inputted to the gate of the first-second input PMOS transistor IPT1_2 is low, the first level shifter 232 outputs the second level voltage as the first output signal LS1 and the ground voltage VSSH as the first inverted output signal LSB1.

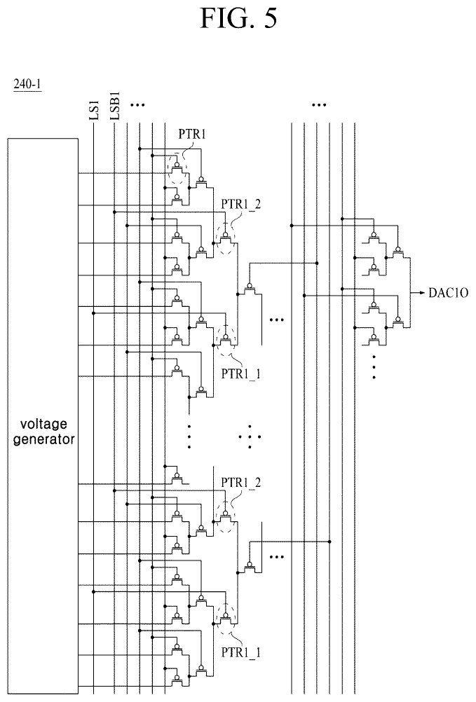

Hereinafter, with reference to FIGS. 4 and 5, the on/off relationship of the DAC transistors according to the first output signal and the first inverted output signal outputted from the first level shifter will be described.

FIG. 4 is a diagram illustrating a first output signal and a first inverted output signal outputted from a first level shifter, and FIG. 5 is a circuit diagram of a first DAC included in the source driver IC of FIG. 2.

As shown in FIG. 4, when the first output signal LS1 transitions from a low level LOW to a high level HIGH and the first inverted output signal LSB1 transitions from the high level HIGH to the low level LOW, that is, when the first output signal LS1 has a rising edge and the first inverted output signal LSB1 has a falling edge, among first DAC PMOS transistors PTR1 included in the first DAC 240_1, a first-first DAC PMOS transistor PTR1_1, to which the first output signal LS1 is inputted, changes from a turn-on state to a turn-off state, and a first-second DAC PMOS transistor PTR1_2, to which the first inverted output signal LSB1 is inputted, changes from a turn-off state to a turn-on state. As may be seen in FIGS. 4 and 5, the slope of the rising edge of the first output signal LS1 increases, causing the first-first DAC PMOS transistor PTR1_1 to be turned off before the first-second DAC PMOS transistor PTR1_2 is turned on. This prevents the simultaneous turn-on between the first-first DAC PMOS transistor PTR1_1 and the first-second DAC PMOS transistor PTR1_2, thereby preventing a DAC short.

On the other hand, when the first output signal LS1 transitions from the high level HIGH to the low level LOW and the first inverted output signal LSB1 transitions from the low level LOW to the high level HIGH, that is, when the first output signal LS1 has a falling edge and the first inverted output signal LSB1 has a rising edge, among the first DAC PMOS transistors included in the first DAC 240_1, the first-first DAC PMOS transistor PTR1_1, to which the first output signal LS1 is inputted, changes from a turn-off state to a turn-on state, and the first-second DAC PMOS transistor PTR1_2, to which the first inverted output signal LSB1 is inputted, changes from a turn-on state to a turn-off state. Accordingly, the slope of the rising edge of the first inverted output signal LSB1 increases, causing the first-second DAC PMOS transistor PTR1_2 to be turned off before the first-first DAC PMOS transistor PTR1_1 is turned on. This prevents the simultaneous turn-on between the first-first DAC PMOS transistor PTR1_1 and the first-second DAC PMOS transistor PTR1_2, thereby preventing a DAC short. As a result, the driving delay time of the source driver IC is reduced, thereby securing the output driving time for a high-resolution display and improving image quality.

In the above-described aspect, the first level shifter 232 has been described as being implemented as a single level shifter 232. However, in another aspect, the first level shifter 232 may be composed of two sub-level shifters. In this case, the two sub-level shifters may be connected in series with each other. That is, the output of one sub-level shifter is used as the input of the other sub-level shifter.

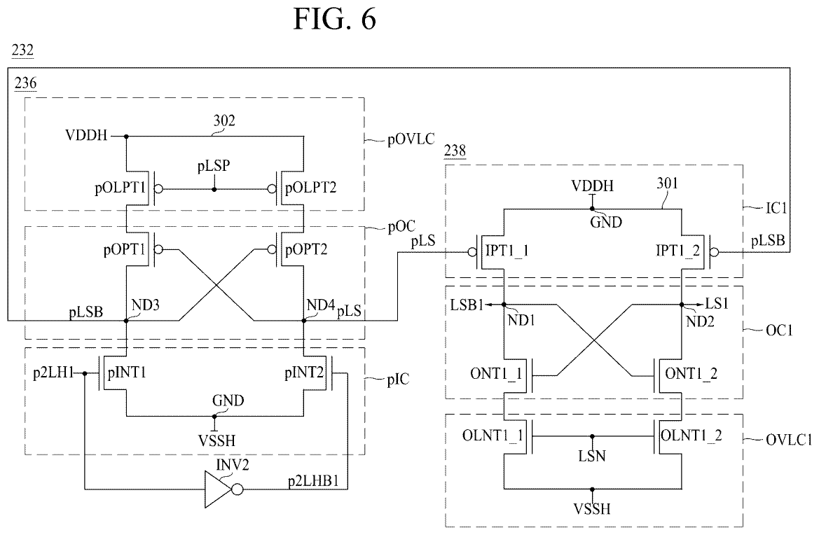

Hereinafter, with reference to FIG. 6, the first level shifter composed of two sub-level shifters will be described in detail.

FIG. 6 is a circuit diagram of a first level shifter according to another aspect of the present disclosure. As shown in FIG. 6, the first level shifter 232 according to another aspect of the present disclosure includes a first sub-level shifter 236 and a second sub-level shifter 238. The second sub-level shifter 238 has the same configuration as the first level shifter 232 shown in FIG. 3, and therefore a detailed description thereof will be omitted.

The first sub-level shifter 236 shifts a pre-input signal p2LH1 at a third level voltage to a pre-output signal pLS at a fourth level voltage and an inverted pre-output signal pLSB obtained by inverting the pre-output signal pLS. Accordingly, the first sub-level shifter 236 outputs the complementary signal pair pLS and pLSB to the second sub-level shifter 238. In this case, the pre-output signal pLS at the fourth level voltage may be the first input signal LS1, which is the aforementioned input signal at the first level voltage, and the inverted pre-output signal pLSB at the fourth level voltage may be the aforementioned first inverted input signal LSB1 at the first level voltage. In such a case, the first inverter INV1 for input signal inversion may be omitted in the first level shifter 232 described above.

To this end, the first sub-level shifter 236 includes a pre-input circuit pIC, a pre-output circuit pOC, and a pre-output limiting circuit pOVLC.

The pre-input circuit pIC receives a pre-input signal p2LH1 at the third level voltage and an inverted pre-input signal p2LHB1 obtained by inverting the pre-input signal p2LH1. For this purpose, the pre-input circuit pIC includes a first pre-NMOS transistor pINT1 and a second pre-NMOS transistor pINT2.

The gate of the first pre-NMOS transistor pINT1 receives the pre-input signal p2LH1 at the third level voltage, the first terminal of the first pre-NMOS transistor pINT1 is connected to the ground GND for supplying the ground voltage VSSH, and the second terminal of the first pre-NMOS transistor pINT1 is connected to a third node ND3.

The gate of the second pre-NMOS transistor pINT2 receives the inverted pre-input signal p2LHB1. In this case, a second inverter INV2 inverts the pre-input signal p2LH1 and inputs the inverted pre-input signal p2LHB1 to the gate of the second pre-NMOS transistor pINT2. The first terminal of the second pre-NMOS transistor pINT2 is connected to the ground GND for supplying the ground voltage VSSH, and the second terminal of the second pre-NMOS transistor pINT2 is connected to a fourth node ND4.

In this case, when the level of the pre-input signal p2LH1 inputted to the gate of the first pre-NMOS transistor pINT1 is high and the level of the inverted pre-input signal p2LHB1 inputted to the gate of the second pre-NMOS transistor pINT2 is low, the first pre-NMOS transistor pINT1 is turned on and the second pre-NMOS transistor pINT2 is turned off. Conversely, when the level of the pre-input signal p2LH1 inputted to the gate of the first pre-NMOS transistor pINT1 is low and the level of the inverted pre-input signal p2LHB1 inputted to the gate of the second pre-NMOS transistor pINT2 is high, the first pre-NMOS transistor pINT1 is turned off and the second pre-NMOS transistor pINT2 is turned on.

The pre-output circuit pOC is a circuit that outputs the pre-output signal pLS and the inverted pre-output signal pLSB obtained by inverting the pre-output signal pLS, and includes a third pre-PMOS transistor pOPT1 and a fourth pre-PMOS transistor pOPT2.

The pre-output limiting circuit pOVLC receives the pre-bias voltage pLSP and limits the voltage levels of the pre-output signal pLS and the inverted pre-output signal pLSB to the fourth level voltage.

The pre-output limiting circuit pOVLC includes a fifth pre-PMOS transistor pOLPT1 and a sixth pre-PMOS transistor pOLPT2. The pre-output limiting circuit pOVLC limits the voltage levels of the pre-output signal pLS and the inverted pre-output signal pLSB to the fourth level voltage by inputting the pre-bias voltage pLSP to the gates of the fifth pre-PMOS transistor pOLPT1 and the sixth pre-PMOS transistor pOLPT2. The pre-output signal pLS may be inputted to the first-first input PMOS transistor IPT1_1 of the second level shifter 238, and the inverted pre-output signal pLSB may be inputted to the first-second input PMOS transistor IPT1_2 of the second level shifter 238.

Hereinafter, with reference to FIG. 6, the connection relationship of the transistors included in the first level shifter composed of two sub-level shifters and the operation of each transistor will be described in more detail.

As shown in FIG. 6, the transistors pOLPT1, pOPT1, and pINT1 are connected in series between a second voltage transmission line 302 for transmitting the first operating voltage VDDH and the ground GND for supplying the ground voltage VSSH, and the transistors pOLPT2, pOPT2, and pINT2 are connected in series between the second voltage transmission line 302 and the ground GND.

The gate of the third pre-PMOS transistor pOPT1 is connected to the fourth node ND4, the first terminal of the third pre-PMOS transistor pOPT1 is connected to the third node ND3, and the second terminal of the third pre-PMOS transistor pOPT1 is connected to the fifth pre-PMOS transistor pOLPT1.

The gate of the fourth pre-PMOS transistor pOPT2 is connected to the third node ND3, the first terminal of the fourth pre-PMOS transistor pOPT2 is connected to the fourth node ND4, and the second terminal of the fourth pre-PMOS transistor pOPT2 is connected to the sixth pre-PMOS transistor pOLPT2.

The gate of the fifth pre-PMOS transistor pOLPT1 receives the pre-bias voltage pLSP, the first terminal of the fifth pre-PMOS transistor pOLPT1 is connected to the third pre-PMOS transistor pOPT1, and the second terminal of the fifth pre-PMOS transistor pOLPT1 is connected to the second voltage transmission line 302 for transmitting the first operating voltage VDDH.

The gate of the sixth pre-PMOS transistor pOLPT2 receives the pre-bias voltage pLSP, the first terminal of the sixth pre-PMOS transistor pOLPT2 is connected to the fourth pre-PMOS transistor pOPT2, and the second terminal of the sixth pre-PMOS transistor pOLPT2 is connected to the second voltage transmission line 302 for transmitting the first operating voltage VDDH.

In one aspect, the fifth pre-PMOS transistor pOLPT1 and the sixth pre-PMOS transistor pOLPT2 are turned on by receiving the pre-bias voltage pLSP at their gates, and the voltages applied to their respective first terminals are limited by the pre-bias voltage pLSP, so that the pre-output signal pLS and the inverted pre-output signal pLSB outputted to the third node ND3 and the fourth node ND4 may be limited to the fourth level voltage.

In one aspect, when the level of the pre-input signal p2LH1 inputted to the gate of the first pre-NMOS transistor pINT1 is low and the level of the inverted pre-input signal p2LHB1 inputted to the gate of the second pre-PMOS transistor pIPT2 is high, the first pre-NMOS transistor pINT1 is turned off and the second pre-NMOS transistor pINT2 is turned on. When the second pre-NMOS transistor pINT2 is turned on, the pre-output signal pLS, which is the voltage at the fourth node ND4, is pulled down to the ground voltage VSSH, and the third pre-PMOS transistor pOPT1 is turned on, causing the voltage pLSB at the third node ND3 to be pulled up to the fourth level voltage limited by the fifth pre-PMOS transistor pOLPT1. Accordingly, the fourth pre-PMOS transistor pOPT2 is turned off, and thus the pre-output signal pLS, which is the voltage at the fourth node ND4, is maintained at the ground voltage VSSH. That is, when the level of the pre-input signal p2LH1 inputted to the gate of the first pre-NMOS transistor pINT1 is low and the level of the first inverted input signal 2LHB1 inputted to the gate of the second pre-NMOS transistor pINT2 is high, the first sub-level shifter 236 outputs the ground voltage VSSH as the pre-output signal pLS and the fourth level voltage as the inverted pre-output signal pLSB.

Conversely, when the level of the pre-input signal p2LH1 inputted to the gate of the first pre-NMOS transistor pINT1 is high and the level of the inverted pre-input signal p2LHB1 inputted to the gate of the second pre-NMOS transistor pINT2 is low, the first pre-NMOS transistor pINT1 is turned on and the second pre-NMOS transistor pINT2 is turned off. When the first pre-NMOS transistor pINT1 is turned on, the voltage pLSB at the third node ND3 is pulled down to the ground voltage VSSH, and the fourth pre-PMOS transistor pOPT2 is turned on, causing the pre-output signal pLS, which is the voltage at the fourth node ND4, to be pulled up to the fourth level voltage limited by the sixth pre-PMOS transistor pOLPT2. Accordingly, the third pre-PMOS transistor pOPT1 is turned off, and thus the voltage pLSB at the third node ND3 maintains the ground voltage VSSH. That is, when the level of the pre-input signal p2LH1 inputted to the gate of the first pre-NMOS transistor pINT1 is high and the level of the first inverted input signal 2LHB1 inputted to the gate of the second pre-NMOS transistor pINT2 is low, the first level shifter 232 outputs the fourth level voltage as the pre-output signal pLS and the ground voltage VSSH as the inverted pre-output signal pLSB.

In one aspect, the second sub-level shifter 238 receives the pre-output signal pLS at the fourth level voltage outputted from the first sub-level shifter 236 as the first input signal, an inverted pre-output signal pLSB as the first inverted input signal pLSB, and outputs the first output signal LS1 and the first inverted output signal LSB1 at the second level voltage. In this case, unlike the first level shifter 232 shown in FIG. 3, since the second sub-level shifter 238 receives the pre-output signal pLS and the inverted pre-output signal pLSB obtained by inverting the pre-output signal pLS, the first inverter INV1 may be omitted.

In the above-described aspect, the reason for implementing the first level shifter 232 with the two sub-level shifters 236 and 238 is to distinguish between a level shifter for applying an input signal and a level shifter for applying a bias voltage, because, to implement an N-bias type level shifter for applying a bias voltage to an NMOS transistor, both the input signal and the bias voltage need to be simultaneously applied to the NMOS transistor, which may degrade the characteristics of the level shifter. Thus, according to the present disclosure, by configuring the first level shifter 232 with the first and second sub-level shifters 236 and 238, it becomes possible to implement an N-bias type level shifter without degrading circuit characteristics.

Referring back to FIG. 2, in response to the complementary signal pair LS1 and LSB1 outputted from the first level shifter 232, the first DAC 240_1 outputs a corresponding grayscale voltage VGMA as a first output signal DAC10.

The first output circuit 250_1 buffers the first output signal DACIO of the first DAC 240_1 and outputs the buffered first output signal OUT1 to at least one of the first data lines DL1.

The second data processing circuit 205_2 receives the second data DATA2 outputted from the control logic circuit 202, processes it (e.g., sequentially performs a latch operation, a serial-to-parallel converting operation, a voltage level shifting operation, and a digital-to-analog converting operation), and outputs a processing result OUT2 to another one of the first data lines DL1.

The second data processing circuit 205_2 includes a third latch circuit 210_2, a fourth latch circuit 220_2, a second level shifter circuit 230_2, a second DAC 240_2, and a second output circuit 250_2.

The third latch circuit 210_2 includes third latches 214, and latches (or converts) the serial second data DATA2 into parallel second data 1LH2 in response to the first latch enable signals EN1. For example, the third latches 214 may be D-flip-flops capable of latching 1-bit data, and the first latch enable signals ENI may be parallel signals activated at different timings.

The activation timing of each of the first latch enable signals EN1 supplied to the first latch circuit 210_1 and the activation timing of each of the first latch enable signals EN1 supplied to the third latch circuit 210_3 are different. Therefore, the third latch circuit 210_2 does not operate when the first latch circuit 210_1 operates.

The fourth latch circuit 220_2 includes fourth latches 224, and the fourth latches 224 latch the data 1LH2 in response to the second latch enable signal EN2 and outputs latched data 2LH2 to the second level shifter circuit 230_2.

The second level shifter circuit 230_2 shifts the data 2LH2 outputted from the fourth latch circuit 220_2 to a predetermined level voltage and outputs the shifted data. For this purpose, the second level shifter circuit 230_2 includes second level shifters 234.

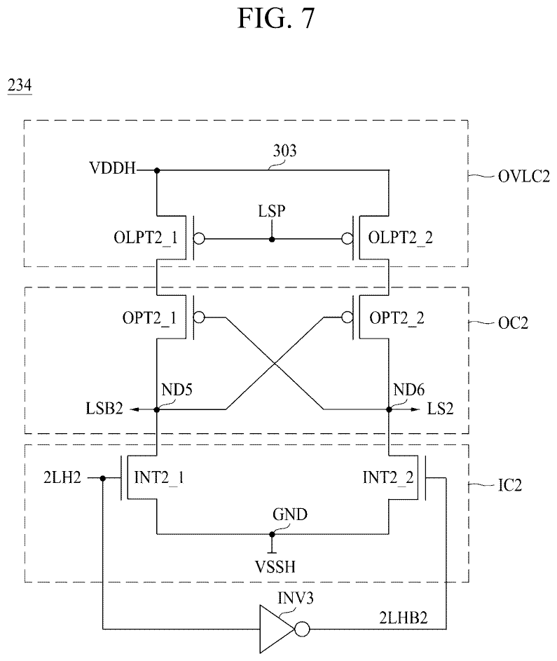

Hereinafter, the configuration of the second level shifter will be described in more detail with reference to FIGS. 2 and 7.

FIG. 7 is a circuit diagram of the second level shifter included in the source driver IC of FIG. 2. The second level shifter 234 shown in FIG. 7 may be a level shifter connected to the second DAC 240_2 composed of n-type transistors.

The second level shifter 234 shown in FIG. 7 shifts the first input signal 2LH2 at a fifth level voltage to a second output signal LS2 at a sixth level voltage and a second inverted output signal LSB2 obtained by inverting the second output signal LS2. Accordingly, the second level shifter 234 outputs the complementary signal pair LS2 and LSB2 to the second DAC 240_2.

To this end, the second level shifter 234 includes a second input circuit IC2, a second output circuit OC2, and a second output limiting circuit OVLC2.

The second input circuit IC2 receives the second input signal 2LH2 at the fifth level voltage and a second inverted input signal 2LHB2 obtained by inverting the second input signal 2LH2. For this purpose, the second input circuit IC2 includes a second-first input NMOS transistor INT2_1 and a second-second input NMOS transistor INT2_2.

The gate of the second-first input NMOS transistor INT2_1 receives the second input signal 2LH2 at the fifth level voltage, the first terminal of the second-first input NMOS transistor INT2_1 is connected to the ground GND for supplying the ground voltage VSSH, and the second terminal of the second-first input NMOS transistor INT2_1 is connected to a fifth node ND5.

The gate of the second-second input NMOS transistor INT2_2 receives the second inverted input signal 2LHB2. In this case, a third inverter INV3 inverts the second input signal 2LH2, and inputs the inverted second inverted input signal 2LHB2 to the gate of the second-second input NMOS transistor INT2_2. The first terminal of the second-second input NMOS transistor INT2_2 is connected to the ground GND for supplying the ground voltage VSSH, and the second terminal of the second-second input NMOS transistor INT2_2 is connected to a sixth node ND6.

In this case, when the level of the second input signal 2LH2 inputted to the gate of the second-first input NMOS transistor INT2_1 is high and the level of the second inverted input signal 2LHB2 inputted to the gate of the second-second input NMOS transistor INT2_2 is low, the second-first input NMOS transistor INT2_1 is turned on and the second-second input NMOS transistor INT2_2 is turned off. Conversely, when the level of the second input signal 2LH2 inputted to the gate of the second-first input NMOS transistor INT2_1 is low and the level of the second inverted input signal 2LHB2 inputted to the gate of the second-second input NMOS transistor INT2_2 is high, the second-first input NMOS transistor INT2_1 is turned off and the second-second input NMOS transistor INT2_2 is turned on.

The second output circuit OC2 is a circuit that outputs the second output signal LS2 and the second inverted output signal LSB2 obtained by inverting the second output signal LS2, and includes a second-first output PMOS transistor OPT2_1 and a second-second output PMOS transistor OPT2_2.

The second output limiting circuit OVLC2 receives the second bias voltage LSP and limits the voltage levels of the second output signal LS2 and the second inverted output signal LSB2 to the sixth level voltage.

In particular, when the second level shifter 234 is connected to the second DAC 240_2 composed of n-type transistors, the second output limiting circuit OVLC2 according to the present disclosure may adjust the slope characteristics of the rising edge of the second output signal LS2 and the falling edge of the second inverted output signal LSB2 through the application of the second bias voltage LSP. The second output limiting circuit OVLC2 outputs the second output signal LS2 and the second inverted output signal LSB2 with adjusted slope characteristics to the second DAC 240_2 to prevent a DAC short caused by the simultaneous turn-on of a DAC transistor to which the second output signal LS2 is inputted and a DAC transistor to which the second inverted output signal LSB2 is inputted, thereby reducing the current consumption in the source driver IC.

To this end, the second output limiting circuit OVLC2 includes a second-first output limiting PMOS transistor OLPT2_1 and a second-second output limiting PMOS transistor OLPT2_2. The second output limiting circuit OVLC2 inputs the second bias voltage LSP to the gates of the second-first output limiting PMOS transistor OLPT2_1 and the second-second output limiting PMOS transistor OLPT2_2, which are p-type transistors, thereby allowing the slope of the falling edge of the second inverted output signal LSB2 to increase. This is because a P-bias type, in which a bias voltage is applied to the gates of the second-first output limiting PMOS transistor OLPT2_1 and the second-second output limiting PMOS transistor OLPT2_2, is characterized by fast rising and slow falling edges, which increases the slope of the falling edge of the second inverted output signal LSB2 finally outputted from the second level shifter 234, thereby enhancing the turn-off characteristics of the DAC transistors.

As a result, the transition time from turn-on to turn-off of a second-second DAC NMOS transistor, to which the second inverted output signal LSB2 is inputted, is reduced compared to the transition time from turn-off to turn-on of a second-first DAC NMOS transistor, to which the second output signal LS2 is inputted. In other words, the turn-off of the second-second DAC NMOS transistor is performed before the turn-on of the second-first DAC NMOS transistor, thereby preventing the occurrence of a DAC short circuit caused by the simultaneous turn-on of the second-first DAC NMOS transistor and the second-second DAC NMOS transistor.

Hereinafter, with reference to FIG. 7, the connection relationship of the transistors included in the second level shifter 234 and the operation of each transistor will be described in more detail.

As shown in FIG. 7, the transistors OLPT2_1, OPT2_1, and INT2_1 are connected in series between a third voltage transmission line 303 for transmitting the first operating voltage VDDH and the ground GND for supplying the ground voltage VSSH, and the transistors OLPT2_2, OPT2_2, and INT2_2 are connected in series between the third voltage transmission line 303 and the ground GND.

The gate of the second-first output PMOS transistor OPT2_1 is connected to the sixth node ND6, the first terminal of the second-first output PMOS transistor OPT2_1 is connected to the fifth node ND5, and the second terminal of the second-first output PMOS transistor OPT2_1 is connected to the second-first output limiting PMOS transistor OLPT2_1. The gate of the second-second output PMOS transistor OPT2_2 is connected to the fifth node ND5, the first terminal of the second-second output PMOS transistor OPT2_2 is connected to the sixth node ND6, and the second terminal of the second-second output PMOS transistor OPT2_2 is connected to the second-second output limiting PMOS transistor OLPT2_2.

The gate of the second-first output limiting PMOS transistor OPT2_1 receives the second bias voltage LSP, the first terminal of the second-first output limiting PMOS transistor OLPT2_1 is connected to the second-first output PMOS transistor OPT2_1, and the second terminal of the first-first output limiting NMOS transistor OLNT1-1 is connected to the third voltage transmission line 303 for transmitting the first operating voltage VDDH.

The gate of the second-second output limiting PMOS transistor OLPT2_2 receives the second bias voltage LSP, the first terminal of the second-second output limiting PMOS transistor OLPT2_2 is connected to the second-second output PMOS transistor OPT2_2, and the second terminal of the second-second output limiting PMOS transistor OLPT2_2 is connected to the third voltage transmission line 303 for transmitting the first operating voltage VDDH.

In one aspect, the second-first output limiting PMOS transistor OLPT2_1 and the second-second output limiting PMOS transistor OLPT2_2 are turned on by receiving the second bias voltage LSP at their gates, and the voltages applied to their respective first terminals are limited by the second bias voltage LSP, so that the second output signal LS2 and the second inverted output signal LSB2 outputted to the fifth node ND5 and the sixth node ND6 may be limited to the sixth level voltage. Additionally, due to the unique characteristics of the P-bias type in which a bias voltage is applied to a P-type transistor, the slope of the falling edge of the second inverted output signal LSB2 increases, reducing the transition time from turn-on to turn-off of the second-second DAC NMOS transistor to which the second inverted output signal LSB2 is inputted, thereby preventing a short circuit between the second-first DAC NMOS transistor and the second-second DAC NMOS transistor.

In one aspect, when the level of the second input signal 2LH2 inputted to the gate of the second-first input NMOS transistor INT2_1 is low and the level of the first inverted input signal 2LHB2 inputted to the gate of the first-second input PMOS transistor IPT1_2 is high, the second-first input NMOS transistor INT2_1 is turned off and the second-second input NMOS transistor INT2_2 is turned on. When the first-second input NMOS transistor INT2_1 is turned on, the second output signal LS2, which is the voltage at the sixth node ND6, is pulled down to the ground voltage VSSH, and the second-first output PMOS transistor OPT2_1 is turned on, causing the voltage LSB2 at the fifth node ND5 to be pulled up to the sixth level voltage limited by the second-first output limiting PMOS transistor OLPT2_1. Accordingly, the second-second output PMOS transistor OPT2_2 is turned off, and thus the second output signal LS2, which is the voltage at the sixth node ND6, is maintained at the ground voltage VSSH. That is, when the level of the second input signal 2LH2 inputted to the gate of the second-first input NMOS transistor INT2_1 is low, and the level of the first inverted input signal 2LHB2 inputted to the gate of the second-second input NMOS transistor INT2_2 is high, the second level shifter 234 outputs the ground voltage VSSH as the second output signal LS2 and outputs the sixth level voltage as the second inverted output signal LSB2.

Conversely, when the level of the second input signal 2LH2 inputted to the gate of the second-first input NMOS transistor INT2_1 is high and the level of the first inverted input signal 2LHB2 inputted to the gate of the second-second input NMOS transistor INT2_2 is low, the second-first input NMOS transistor INT2_1 is turned on and the second-second input NMOS transistor INT2_2 is turned off. When the second-first input NMOS transistor INT2_1 is turned on, the voltage LSB2 at the fifth node ND5 is pulled down to the ground voltage VSSH, and the second-second output PMOS transistor OPT2_2 is turned on, causing the second output signal LS2, which is the voltage at the sixth node ND6, is pulled up to the sixth level voltage limited by the second-second output limiting PMOS transistor OLPT2_2. Accordingly, the second-first output PMOS transistor OPT2_1 is turned off, and thus the voltage LSB2 at the fifth node ND5 is pulled down to the ground voltage VSSH. That is, when the level of the second input signal 2LH2 inputted to the gate of the second-first input NMOS transistor INT2_1 is high, and the level of the first inverted input signal 2LHB2 inputted to the gate of the second-second input NMOS transistor INT2_2 is low, the second level shifter 234 outputs the sixth level voltage as the second output signal LS2, and the ground voltage VSSH as the second inverted output signal LSB2.

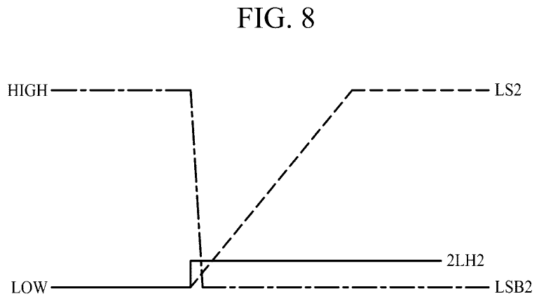

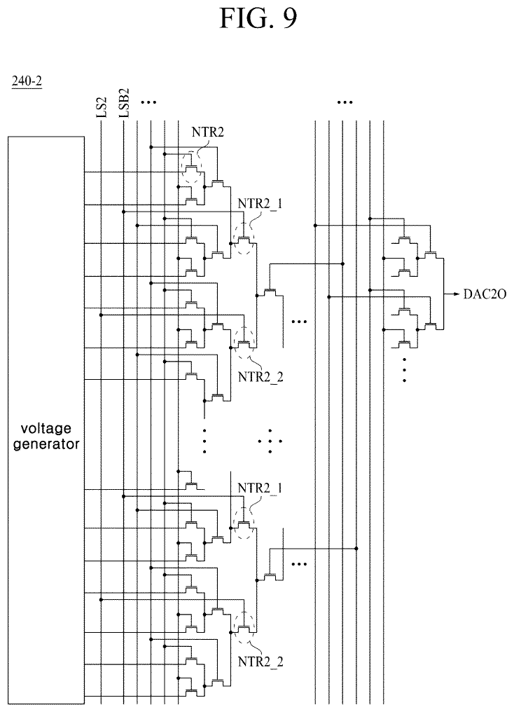

Hereinafter, with reference to FIGS. 8 and 9, the on-off relationship of the DAC transistors according to the second output signal and the second inverted output signal outputted from the second level shifter will be described.

FIG. 8 is a diagram illustrating a second output signal and a second inverted output signal outputted from a second level shifter, and FIG. 9 is a circuit diagram of a second DAC included in the source driver IC of FIG. 2.

As shown in FIG. 8, when the second output signal LS2 transitions from the low level LOW to the high level HIGH and the second inverted output signal LSB2 transitions from the high level HIGH to the low level LOW, that is, when the second output signal LS2 has a rising edge and the second inverted output signal LSB2 has a falling edge, among second DAC NMOS transistors NTR2 included in the second DAC 240_2, a second-first DAC NMOS transistor NTR2_1, to which the second output signal LS2 is inputted, changes from a turn-off state to a turn-on state, and a second-second DAC NMOS transistor NTR2_2, to which the second inverted output signal LSB2 is inputted, changes from a turn-on state to a turn-off state. As may be seen in FIG. 8, the slope of the falling edge of the second inverted output signal LSB2 increases, causing the second-second DAC NMOS transistor NTR2_2 to be turned off before the second-first DAC NMOS transistor NTR2_1 is turned on. This prevents the simultaneous turn-on between the second-first DAC NMOS transistor NTR2_1 and the second-second DAC NMOS transistor NTR2_2, thereby preventing a DAC short.

On the other hand, when the second output signal LS2 transitions from the high level HIGH to the low level LOW and the second inverted output signal LSB2 transitions from the low level LOW to the high level HIGH, that is, when the second output signal LS2 has a falling edge and the second inverted output signal LSB2 has a rising edge, among the second DAC NMOS transistors NTR2 included in the second DAC 240_2, the second-first DAC NMOS transistor, to which the second output signal LS2 is inputted, changes from a turn-on state to a turn-off state, and the second-second DAC NMOS transistor, to which the second inverted output signal LSB2 is inputted, changes from a turn-off state to a turn-on state. Accordingly, the slope of the falling edge of the second output signal LS2 increases, and the second-first DAC NMOS transistor is turned off before the second-second DAC NMOS transistor is turned on. This prevents the simultaneous turn-on between the second-first DAC NMOS transistor and the second-second DAC NMOS transistor, thereby preventing a DAC short. As a result, the driving delay time of the source driver IC is reduced, thereby securing the output driving time of a high-resolution display and improving image quality.

Referring back to FIG. 2, in response to the complementary signal pair LS2 and LSB2 outputted from the second level shifter 234, the second DAC 240_2 outputs a corresponding grayscale voltage VGMA as a second output signal DAC20.

The second output circuit 250_2 buffers the second output signal DAC20 of the second DAC 240_2 and outputs the buffered second output signal OUT2 to another one of the first data lines DL1.

Meanwhile, the first and second level shifters 232 and 234 according to the present disclosure may adjust the slopes of the output signal and the inverted output signal according to the number of DAC transistors included in the first DAC 240_1 and the second DAC 240_2.

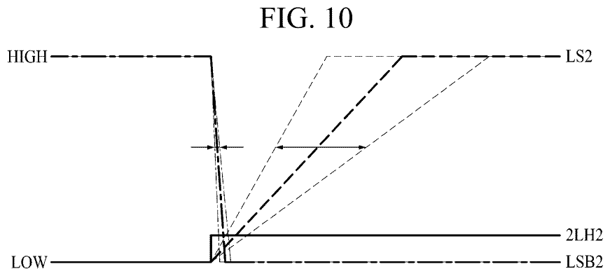

Hereinafter, a method in which the second level shifter 234 adjusts the slopes of the second output signal 2LS and the second inverted output signal 2LSB according to the number of DAC transistors included in the second DAC 240_2 will be described in detail with reference to FIG. 10.

FIG. 10 is a diagram illustrating a second output signal and a second inverted output signal outputted from a second level shifter.

The second output limiting circuit OVLC2 may, as shown in FIG. 10, adjust the slopes of the rising edge of the second output signal D2_1 or the falling edge of the second inverted output signal DB2_1, by adjusting the magnitude of the second bias voltage LSP applied to the second-first output limiting PMOS transistor OLPT2_1 and the second-second output limiting PMOS transistor OLPT2_2 according to the number of transistors included in the second DAC 240_2.

Specifically, when the number of the second DAC NMOS transistors NTR2 constituting the second DAC 240_2 is increased to raise the load on the DAC, the amount of current flowing through the data line DL connected to the second DAC 240_2 may be controlled by adjusting the second bias voltage LSP supplied to the second level shifter 234 connected to the second DAC 240_2. That is, in the second level shifter 234 connected to the second DAC 240_2, as shown in FIG. 10, the slope of the rising edge of the second output signal LS2 and the slope of the falling edge of the second inverted output signal LSB2 may vary depending on the second bias voltage LSP.

For example, as the number of DAC transistors included in the second DAC 240_2 increases, the slope of the rising edge of the second output signal LS2 in the second level shifter 234 connected to the second DAC 240_2 may increase according to the reduced second bias voltage LSP.

In the above-described aspect, only a method in which the second level shifter 234 adjusts the slopes of the second output signal 2LS and the second inverted output signal 2LSB according to the number of DAC transistors included in the second DAC 240_2 has been described. However, the first level shifter 232 may also adjust the slopes of the first output signal ILS and the second inverted output signal 1LSB according to the number of DAC transistors included in the first DAC 240_1.

Those skilled in the art to which the present disclosure belongs will understand that the present disclosure described above may be implemented in other specific forms without changing its technical idea or essential features.

Therefore, it should be understood that the embodiments described above are illustrative in all aspects and do not limit the present disclosure. The scope of the present disclosure is represented by the following claims rather than the above detailed description, and it should be construed that all changes or modifications derived from the meaning and scope of the claims and their equivalent concepts are included within the scope of the present disclosure.

Various embodiments for carrying out the present disclosure have been sufficiently described in the preceding subheadings. Since the present disclosure is applicable to various types of display devices, its industrial applicability is recognized.

1. A display driving device comprising:
a level shifter configured to shift an input signal at a first level voltage and an inverted input signal obtained by inverting the input signal into an output signal at a second level voltage and an inverted output signal obtained by inverting the output signal; and
a digital-to-analog converter (DAC) composed of a plurality of DAC transistors and configured to convert the output signal and the inverted output signal into an analog image signal,
wherein the level shifter includes:
an output limiting circuit configured to limit voltage levels of the output signal and the inverted output signal to the second level voltage by applying a bias voltage to gate terminals of output limiting transistors, such that a turn-on period of a first DAC transistor to which the output signal is inputted does not overlap a turn-on period of a second DAC transistor to which the inverted output signal is inputted.

2. The display driving device of claim 1, wherein:
the first and second DAC transistors are PMOS transistors, and
the output limiting circuit includes a first-first output limiting NMOS transistor and a first-second output limiting NMOS transistor.

3. The display driving device of claim 2, wherein the level shifter further includes:
an input circuit including a first-first input PMOS transistor to which the input signal is applied through a gate terminal, and a first-second input PMOS transistor to which the inverted input signal is applied through a gate terminal; and
an output circuit including a first-first output NMOS transistor that outputs the output signal, and a first-second output NMOS transistor that outputs the inverted output signal.

4. The display driving device of claim 3, wherein:
the gate terminal of the first-first input PMOS transistor receives the input signal, a first terminal of the first-first input PMOS transistor is applied with an operating voltage, and a second terminal of the first-first input PMOS transistor is connected to a first node to which the first-first output NMOS transistor is connected,
the gate terminal of the first-second input PMOS transistor receives the inverted input signal, a first terminal of the first-second input PMOS transistor is applied with the operating voltage, and a second terminal of the first-second input PMOS transistor is connected to a second node to which the first-second output NMOS transistor is connected,
when the first-first input PMOS transistor is turned on and the first-second input PMOS transistor is turned off, the second level voltage is outputted as the inverted output signal through the first node, and a ground voltage is outputted as the output signal through the second node, and
when the first-first input PMOS transistor is turned off and the first-second input PMOS transistor is turned on, the ground voltage is outputted as the inverted output signal through the first node, and the second level voltage is outputted as the output signal through the second node.

5. The display driving device of claim 4, wherein:
the gate terminal of the first-first output limiting transistor receives the bias voltage, a first terminal of the first-first output limiting transistor is connected to the first-first output NMOS transistor, and a second terminal of the first-first output limiting transistor receives the ground voltage, and
the gate terminal of the first-second output limiting transistor receives the bias voltage, a first terminal of the first-second output limiting transistor is connected to the first-second output NMOS transistor, and a second terminal of the first-second output limiting transistor receives the ground voltage.

6. The display driving device of claim 1, further comprising a pre-level shifter configured to generate the input signal and the inverted input signal inputted to the level shifter by using a pre-input signal and an inverted pre-input signal.

7. The display driving device of claim 6, wherein the pre-level shifter includes:
a pre-input circuit including a first pre-NMOS transistor to which the pre-input signal is inputted through its gate terminal, and a second pre-NMOS transistor to which the inverted pre-input signal is inputted through its gate terminal;
a pre-output circuit including a third pre-PMOS transistor that outputs the inverted input signal to the level shifter, and a fourth pre-PMOS transistor that outputs the input signal to the level shifter; and
a pre-output limiting circuit including a fifth pre-PMOS transistor and a sixth pre-PMOS transistor, each of which receives a pre-bias voltage through a gate terminal.

8. A level shifter comprising:
an input circuit to which an input signal and an inverted input signal are inputted;
an output circuit configured to output an output signal generated based on the input signal to a first DAC transistor through a first output line, and to output an inverted output signal generated based on the inverted input signal to a second DAC transistor through a second output line; and
an output limiting circuit configured to adjust a slope of a rising edge of the output signal or a slope of a falling edge of the inverted output signal such that a turn-on period of the first DAC transistor does not overlap a turn-on period of the second DAC transistor.

9. The level shifter of claim 8, wherein the slopes of the output signal and the inverted output signal are adjusted such that a transition time from a turn-on state to a turn-off state of the first DAC transistor is shorter than a transition time from a turn-off state to a turn-on state of the second DAC transistor, and a transition time from a turn-on state to a turn-off state of the second DAC transistor is shorter than a transition time from a turn-off state to a turn-on state of the first DAC transistor.

10. The level shifter of claim 8, wherein:
the first DAC transistor and the second DAC transistor are PMOS transistors, and
the output limiting circuit adjusts the output signal and the inverted output signal by inputting a bias voltage to gate terminals of a first-first output limiting NMOS transistor and a first-second output limiting NMOS transistor, such that the turn-on period of the first DAC transistor does not overlap the turn-on period of the second DAC transistor.
